(19) United States
(12) Patent Application Publication
(10) Pub. No.: US 2006/0170184 A1
(43) Pub. Date: Aug. 3, 2006

(54) Electromagnetic brake device for children's vehicle

(75) Inventors: Yih-Yuan Lan, Chiai County (TW); Wu Ming-Chia, Chiai County (TW)

Correspondence Address: BIRCH STEWART KOLASCH & BIRCH, PO BOX 747, FALLS CHURCH, VA, 22040-0747, US

(73) Assignee: Link Treasure Limited

(21) Appl. No.: 11/326,445

(22) Filed: Jan. 6, 2006

(30) Foreign Application Priority Data
Jan. 11, 2005 (TW) 094200568

(51) Int. Cl. B62K 1/00

(52) U.S. Cl. 280/264

(57) ABSTRACT

An electromagnetic brake device for children's vehicle is provided with an electromagnetic brake base to generate a magnetic force to drive a brake pad so as to rub against a friction brake surface on the electromagnetic base, to slow down or stop the rotation of the transmission shaft, and thereby to brake the wheel set. The brake device for children's vehicle can brake the transmission shaft directly by electromagnetism. The advantage of the present invention including to effort-saving and braking without spring element and thus can cost down and simply the assembly process.

### FIELD OF THE INVENTION

The present invention relates to a children's vehicle electromagnetic brake device. More particularly, to a brake device which utilize magnetism to move a brake pad to brake or slow down a children's vehicle by friction.

### BACKGROUND OF THE INVENTION

The children's vehicle is provided children for riding on it, and since the safety concern for young children, the brake device is of extremely essential. Every country in the world has strict restriction and rules for the brake device of the children's vehicle; for instance, while in operating the brake device, the power supply shall be cut off to the motor per safety regulation and so on.

The related art of braking system for children's vehicle is commonly making use of mechanical brake device such as shown in FIG. 1, wherein the brake pad 14 with a circular shape is put around the most part of the circle of the brake drum 12 on the wheel 10. The hard plastic material of brake drum 12 or the brake pad 14 is available in the market currently. The theory of the brake mechanism is to hoop the brake drum 12 tightly by the brake pad 14 to provide a deceleration force to brake the wheel 10.

The mechanical brake device in the related art, is mainly conveying the power by driven force, and let the brake pad to hoop the brake drum tightly to brake the children's vehicle. Nevertheless, the little force by the children from stepping on the pedal may not be able to stop the vehicle in time and thus may happen dangerously to hit something in front of the children. In addition, the mechanical brake device may yielding an unbalanced force to impose on the wheels, and may also cause a dangerous situations when the braking forces on both of the wheels are asymmetrically.

### SUMMARY OF THE INVENTION

Accordingly, an object of the present invention is to solve the drawbacks of the conventional mechanical brake device, including to ease the brake operation for the young children, to avoid unbalanced brake force to the children's vehicle, and to provide a brake device which may be activated to slow down or brake the vehicle merely by a children's regular stepping force.

To achieve these and other advantages and in accordance with the purpose of the present invention, as embodied and broadly described, an electromagnetic brake device is provided with an electromagnetic brake base to generate a magnetic force to drive a brake pad so as to rub against a friction brake surface of the electromagnetic base, to slow down or stop the rotation of the transmission shaft of a driving motor of the children's vehicle, and thereby to brake the children's vehicle. The brake device for children's vehicle can brake the transmission shaft directly by electromagnetism. The advantage of the present invention including to effort-saving and to brake the vehicle without spring element, and thus can help to cost down and simply the assembly process.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and, together with the description, serve to explain the principles of the invention.

FIG. 1 is a schematic view of a prior art conventional mechanical brake device.

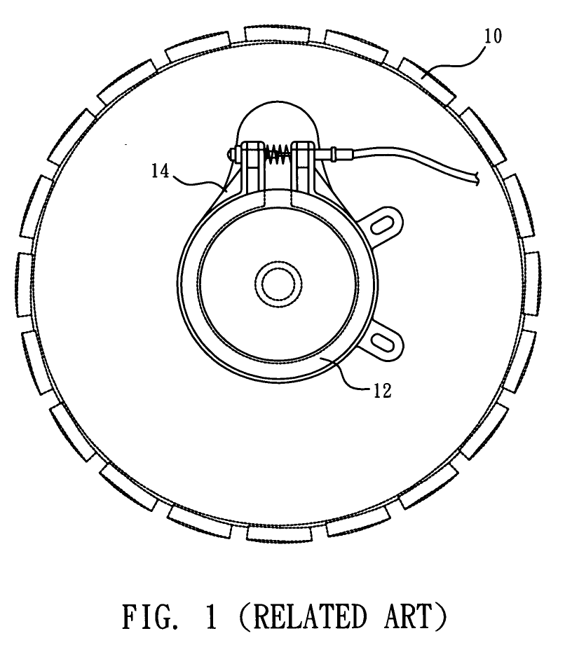

FIG. 2 is an exploded perspective view of the device according to the present invention.

FIG. 3 is a cross sectional view of the brake device according to the present invention.

FIG. 4 is a partial cross sectional view of the brake device which is in a released status according to the present invention.

FIG. 5 is a partial cross sectional view of the brake device which is under operation according to the present invention.

### DETAILED DESCRIPTION OF THE PREFERRED EMBODIMENTS

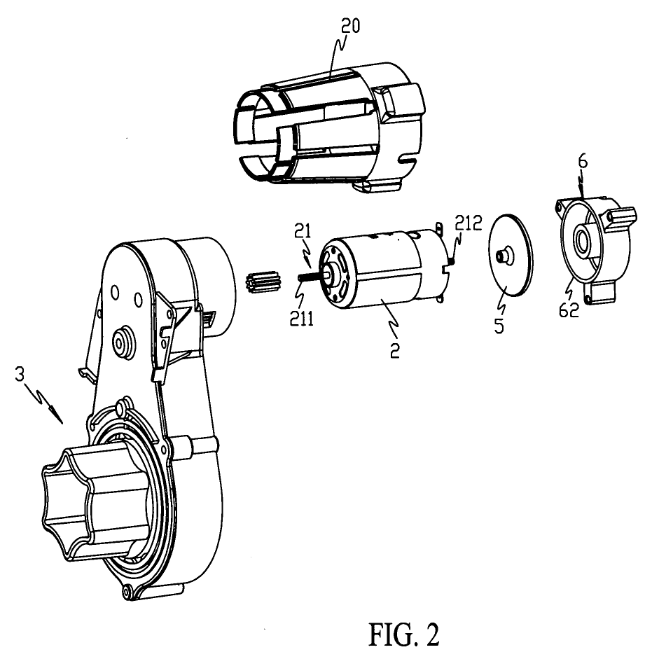

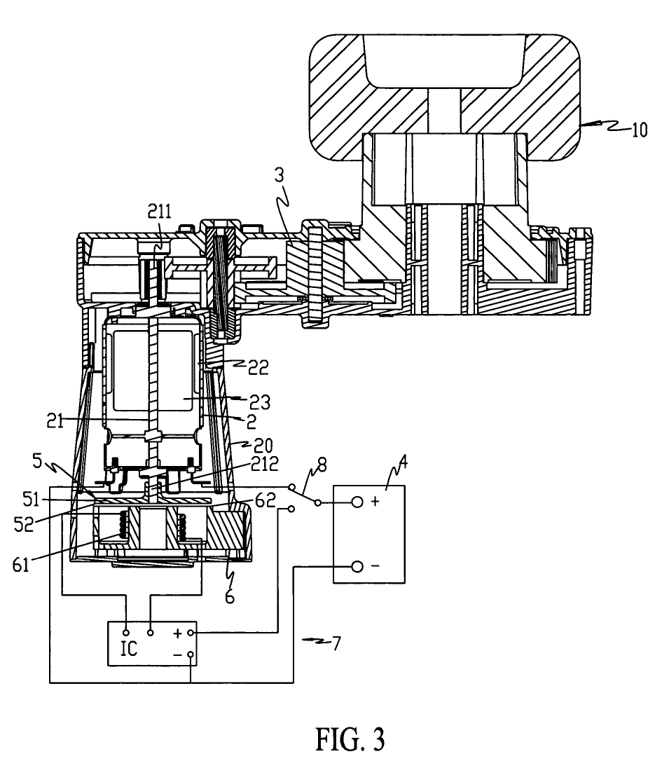

An embodiment of children's vehicle electromagnetic brake device in accordance with the present invention as shown in FIGS. 2 and 3, illustrate the main idea for control the children's vehicle brake and the circuit which can be activated by children's foot step force. The force of electromagnet causes friction for brake and slow down the children's vehicle. The children's vehicle electromagnetic brake device of this invention includes a motor 2, a reduction gear train 3, a power supply 4, a brake pad 5, an electromagnetic brake base 6, a control circuit 7 and an operator 8.

Said casing 20 is fixed to the body of children's vehicle. The motor 2 is provided with a transmission shaft 21. The rotation of the transmission shaft 21 is activated by a magnet 22 inside the motor and the coil 23 which is connected to the transmission shaft 21, and wherein the transmission shaft 21 has a front end 211 and a rear end 212. The transmission shaft 21 can be moved within a limited distance related to the motor 2.

Said reduction gear train 3 is mounted between the front end 211 of the transmission shaft 21 and the wheel set 10, wherein the reduction gear train 3 can provide speeds which are applicable to children by reducing rotational speed of the motor 2.

The power supply 4 provides the electric power for motor 2 for driving the transmission shaft 21 and coil 23. Preferably, the power supply 4 can be a rechargeable battery.

The brake pad 5 is fixedly connected to the rear end 212 of the transmission shaft 21 and is rotated or moved axially along with the transmission shaft 21. The brake pad 5 includes a magnetic portion 51 and a brake surface 52.

The electromagnetic brake base 6 is fixed inside the casing 20 and is arranged opposite the brake pad 5. The electromagnetic brake base 6 is preferably comprising a electromagnetic coil 61 and a friction brake surface 62.

The control circuit 7 is connected between the power supply 4 and the electromagnetic coil 61 inside the electromagnetic brake base 6. The control circuit 7 selectively recharges the electromagnetic coil 61 and generates electromagnetic force for the electromagnetic brake base 6.

The operator 8 is arranged at the children's vehicle and provides the children to stop the children's vehicle by controlling the control circuit.

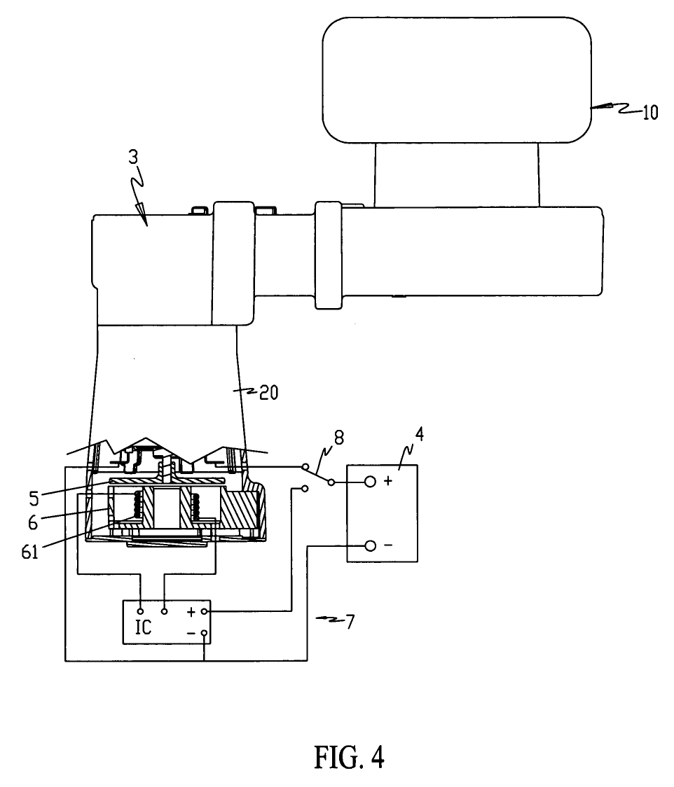

Under the operation of the children's vehicle as shown in FIG.4, the electric power is supplied from the power supply 4 to empower the motor 2 to drive the transmission shaft 21 to rotate, and to drive the wheel set 10 through the transmission of reduction gear train 3. When power on, coil 23 which inside the motor 2 turns into magnetic status; the coil on the transmission shaft 21 then rotates in a position corresponding to the magnet 31. Furthermore, the brake surface 52 of the brake pad 5 which is connected to the rear end 212 of the transmission shaft 21 has a distance with the friction brake surface 62 of the electromagnetic brake base 6; wherein the distance enables the wheel set 10 to rotate smoothly.

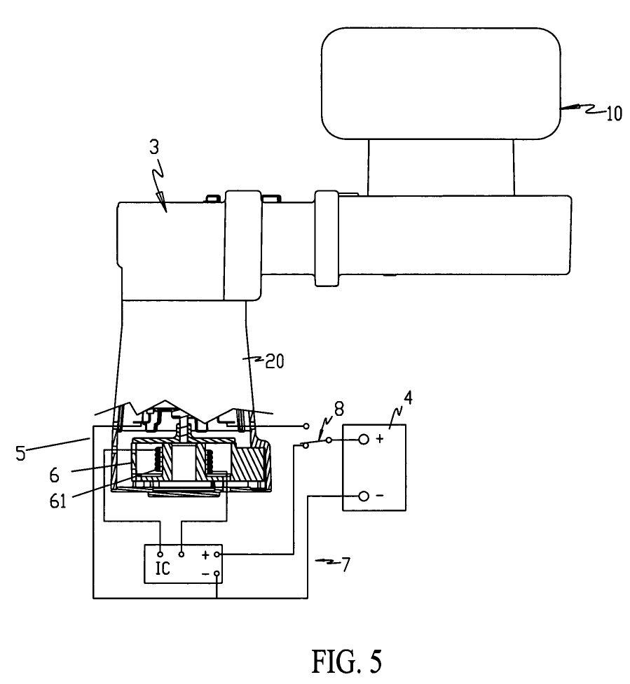

Referring to FIG. 5, when an user needs to slow down or to brake the vehicle, may switch the operator 8 to cut off the power link between the power supply 4 and the motor 2 via the control circuit 7; then empower the electromagnetic coil 61, and then the electromagnetic brake base 6 is charged with magnetism temporally. The temporal magnetism of the electromagnetic brake base 6 is used to drive the brake pad 5 which is arranged at the rear end 212 of the transmission shaft 21, to yield a friction force between the brake surface 52 of the brake pad 5 and the friction brake surface 62 of the electromagnetic brake base 6, and enables the user to slow down or stop the children's vehicle.

Further, in order to reestablish the rotate of the wheel set 10, the user may switch the operator 8 and power off to eliminate the magnetism from the electromagnetic brake base 6, therefore the transmission shaft 21 is driven and rotated axially by the magnetism of the magnet 22 inside the motor 2; the brake surface 52 of the brake pad 5 is then moved away from the friction brake surface 62 of the electromagnetic brake base 6.

In order to prevent the children's vehicle stop suddenly to cause danger, the control circuit 7 is charged the power off and on to the electromagnetic brake base 6, thus may let the electromagnetic brake base 6 produces its magnetism off and on and repeatedly forces the brake pad 5 to slow down or stop the children's vehicle.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electromagnetic brake device for children's vehicle comprising:
a motor having a transmission shaft for driving wheel sets of the children's vehicle;
a brake pad having a magnetic portion and a friction surface, said brake pad is connected to the transmission shaft and can be rotated or forced to move in axially along with the transmission shaft;
an electromagnetic brake base having an electromagnetic coil and a friction brake surface; and
a control circuit for controlling an electric power circuit which is connected to the electromagnetic coil, to generate a magnetic driving force to pull in the magnetic portion of the brake pad while electrified, and the friction surface of the brake pad is forced to rub against the friction brake surface while needed to brake the children's vehicle.

2. The electromagnetic brake device according to claim 1, wherein said transmission shaft includes a front end and a rear end; and wherein the rear end connects to the brake pad, and the front end connects to a reduction gear train and drives the wheel set to rotate.

3. The electromagnetic brake device according to claim 1, wherein said control circuit is selectively providing an electric power to the electromagnetic brake base to brake the children's vehicle and the motor to rotate the transmission shaft to drive the children's vehicle.

4. The electromagnetic brake device according to claim 1, wherein said motor has a magnet and a coil inside the motor.

5. The electromagnetic brake device according to claim 4, wherein said electromagnetic brake base having a magnetic force bigger than the magnet inside the motor, thus to force the transmission shaft to move axially toward the electromagnetic brake base, to force the brake pad to rub against the friction brake surface of said electromagnetic brake base and to brake the children's vehicle.

6. The electromagnetic brake device according to claim 1, wherein said control circuit supplies the power to the electromagnetic brake base inconstantly, and yields the magnetic force off and on via the electromagnetic brake base; therefore to perform deceleration by pulling the brake pad intermittently in a multi-time braking performance.
